(19) United States
(12) Patent Application Publication
(10) Pub. No.: US 2025/0028972 A1
(43) Pub. Date: Jan. 23, 2025

(54) ENTROPY-CONSTRAINED UNIFORM QUANTIZATION

(71) Applicant: VMware LLC, Palo Alto, CA (US)

(72) Inventors: Yaniv Ben-Itzhak, Herzliya (IL); Shay Vargaftik, Herzliya (IL); Ron Dorfman, Haifa (IL)

(21) Appl. No.: 18/466,687

(22) Filed: Sep. 13, 2023

Related U.S. Application Data
(60) Provisional application No. 63/514,280, filed on Jul. 18, 2023.

(51) Int. Cl. G06N 3/098

(52) U.S. Cl. CPC G06N 3/098

(57) ABSTRACT

Embodiments of the present disclosure provide a data compression technique, referred to as entropy-constrained uniform quantization (ECUQ), that performs lossy compression of a real valued vector in a manner that ensures a size budget for the compressed vector. In one set of embodiments, ECUQ achieves this by finding “close-to-the-best” quantization values for quantizing the vector in view of the size budget via a fast and robust search procedure.

### CROSS-REFERENCES TO RELATED APPLICATIONS

The present application claims priority to U.S. Provisional Patent Application No. 63/514,280 filed Jul. 18, 2023 and entitled “Entropy-Constrained Uniform Quantization.” The entire contents of the provisional application are incorporated herein by reference for all purposes.

### BACKGROUND

Unless otherwise indicated, the subject matter described in this section should not be construed as prior art to the claims of the present application and is not admitted as being prior art by inclusion in this section.

Distributed learning (DL) and federated learning (FL) are machine learning techniques that allow multiple networked computing devices/systems, referred to as clients, to collaboratively train an artificial neural network (ANN) under the direction of a central server, referred to as a parameter server. The main distinction between these two techniques is that the training dataset used by each FL client is private to that client and thus inaccessible to other FL clients. In DL, the clients are typically owned/operated by a single entity (e.g., an enterprise) and thus may have access to some or all of the same training data.

DL/FL training proceeds over a series of rounds, where each round typically includes (1) transmitting, by the parameter server, a vector of the ANN's model weights (referred to as a model weight vector) to a participating subset of the clients; (2) executing, by each participating client, a training pass on the ANN and computing a vector of derivatives of a loss function with respect to the model weights (referred to as a gradient); (3) transmitting, by each participating client, its computed gradient to the parameter server; (4) aggregating, by the parameter server, the gradients received from the clients to produce a global gradient; and (5) using, by the parameter server, the global gradient to update the model weights of the ANN. In many cases, the gradients and the model weight vector will be very large because they are proportional in size to the number of parameters in the ANN. Thus, the bandwidth needed to transmit these very large vectors over the network is often the main bottleneck in DL/FL training.

### BRIEF DESCRIPTION OF THE DRAWINGS

FIG. 1 depicts an example DL/FL environment.

FIG. 2 depicts an example ANN.

FIG. 3 depicts a flowchart for compressing a vector using the techniques of the present disclosure according to certain embodiments.

FIG. 4 depicts pseudo-code for implementing the flowchart of FIG. 3 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Example DL/FL Environment and Solution Overview

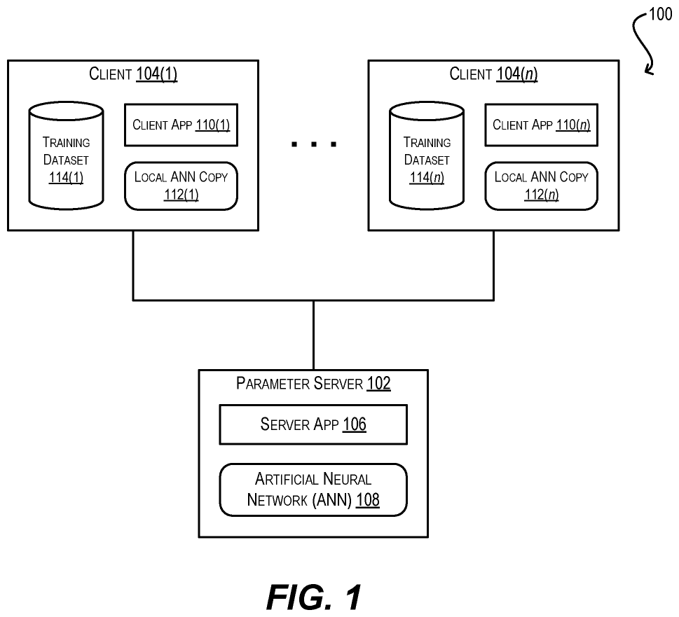

Embodiments of the present disclosure are directed to a novel data compression technique that may be used in distributed and federated learning and other use cases/applications. FIG. 1 is a simplified block diagram of an example DL/FL environment 100 in which these embodiments may be implemented.

As shown, DL/FL environment 100 comprises a parameter server 102 that is communicatively coupled with a set of clients 104(1)-(n). Parameter server 102 and clients 104(1)-(n) may be any type of physical or virtual computing device or system known in the art. Parameter server 102 includes a server application 106 that is programmed to perform the parameter server's DL/FL functions and an ANN 108 to be trained. Each client 104 includes a client application 110 that is programmed to perform the client's DL/FL functions, a local copy 112 of ANN 108, and a local training dataset 114.

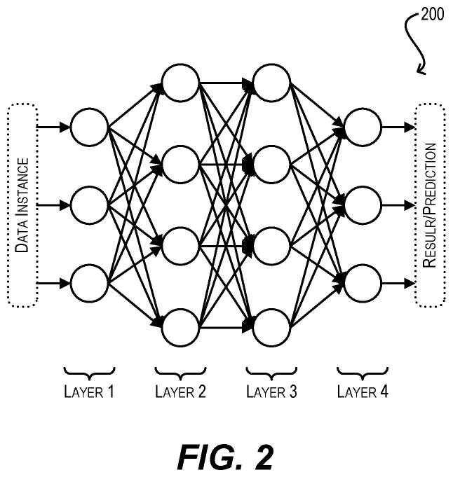

As known in the art, an ANN is a type of machine learning model comprising a collection of nodes that are organized into layers and interconnected via directed edges. By way of example, FIG. 2 depicts an ANN 200 that includes a total of fourteen nodes and four layers 1-4. The edges are associated with parameters (i.e., model weights, not shown) that control how a data instance, which is provided as input to the ANN via the first layer, is processed to generate a result/prediction, which is output by the last layer. These model weights are adjusted via DL/FL training in a round-based manner to optimize the ANN's performance in generating correct results/predictions. For instance, the following is a typical sequence of operations that may be executed by parameter server 102 and clients 104(1)-(n) of FIG. 1 using their respective applications 106 and 110 for training ANN 108 during a single DL/FL training round r:
1. Server application 106 of parameter server 102 selects m out of the n clients to participate in round r.
2. Server application 106 transmits a vector of the current model weights for ANN 108 to each participating client.
3. Client application 110 of each participating client receives the model weight vector and updates the model weights in local ANN copy 112 with the values in this vector.
4. Client application 110 performs a training pass on local ANN copy 112 that involves (a) providing a batch of labeled data instances in training dataset 114 (denoted as the matrix X) as input to local ANN copy 112, resulting in a set of results/predictions f(X); (b) computing a loss vector for X using a loss function L that takes f(X) and the labels of X as input; and (c) computing, based on the loss vector, a vector of derivative values of L with respect to the model weights, referred to as a gradient. Generally speaking, this gradient indicates how much the output of local ANN copy 112 changes in response to changes to the ANN's model weights, in accordance with the loss vector.
5. Client application 110 transmits the gradient to parameter server 102.
6. Server application 106 receives the gradients from the participating clients and computes a global gradient by aggregating the received gradients in some manner (e.g., averaging, etc.).
7. Server application 106 applies a gradient-based optimization algorithm such as gradient descent to update the model weights of ANN 108 in accordance with the global gradient and current round r ends.

Operations (1)-(7) can subsequently be repeated for additional rounds r+1, r+2, etc. until a termination criterion is reached. This termination criterion may be, e.g., a lower bound on the size of the global gradient, an accuracy threshold for ANN 108, or a number of rounds threshold.

As noted in the Background section, an issue with the DL/FL training process above is that the sizes of the model weight vector and gradients transmitted at operations (2) and (5) are proportional to the number of parameters in ANN 108, which can be in the billions. Thus, the network bandwidth needed between clients 104(1)-(n) and parameter server 102 to carry out the training process will often be very high, which is problematic in scenarios where the clients are subject to network connectivity/bandwidth constraints.

To address the foregoing and other similar issues, embodiments of the present disclosure provide a novel lossy data compression technique, referred to as entropy-constrained uniform quantization (ECUQ), that may be used to compress the gradients and/or model weights that are transferred between parameter server 102 and clients 104(1)-(n) during DL/FL training of ANN 108. For example, ECUQ can be used as the “low complexity compression scheme” that is described in co-owned U.S. patent application Ser. No. 18/067,503 entitled “Compression of Model Weights for Distributed and Federated Learning.”

ECUQ can be understood as approximating entropy constrained quantization (ECQ), which is an existing compression technique that takes as input a vector comprising real value coordinates, quantizes the vector, and encodes the quantized vector using an entropy encoding scheme to produce an encoded (i.e., compressed) vector in a manner that guarantees:
a size (or bandwidth) budget for the compressed vector, typically expressed as an average of b bits per coordinate, is respected; and
the quantization values used to quantize the input vector are the “best” values possible (i.e., those that minimize the approximation error introduced by the quantization) in view of the size budget.

Additional details regarding ECQ can be found in the following publication, which is incorporated herein by reference for all purposes: Chou, P. A., Lookabough, T., and Gray, R. M., “Entropy-Constrained Vector Quantization,” IEEE Transactions on Acoustics, Speech, and Signal Processing, Vol. 37, No. 1, pgs. 31-42, January 1989).

While ECQ is capable of producing optimal compression results, this technique is slow, complex, and unstable (i.e., sensitive to hyperparameter selection), which renders it unsuitable for online compression of large vectors such as the gradients and model weight vectors transmitted during DL/FL training.

To overcome these shortcomings, ECUQ solves the same general problem as ECQ—i.e., it performs lossy compression of a real valued vector in a manner that ensures a size budget for the compressed vector is respected—but instead of finding the best quantization values for quantizing the vector in view of the size budget like ECQ (which is slow), ECUQ finds “close-to-the-best” quantization values via a fast and robust search procedure. In certain embodiments, this search procedure involves performing a double binary search to identify a set of uniformly-spaced quantization values (between the minimal and maximal coordinate values of the input vector) that causes the Shannon entropy of the quantized vector to fall within some small threshold below the size budget. ECUQ then quantizes the input vector using the identified quantization values and encodes/compresses the quantized vector using a lossless entropy encoding scheme such as Huffman coding.

Because the quantization values found by ECUQ result in a Shannon entropy that is just below the size budget, the compressed vector it generates will be close to using that entire budget but will not exceed it. Thus, ECUQ guarantees that the size budget is respected while keeping quantization error low (due to the size budget being almost fully utilized). Further, because computing the Shannon entropy of a vector does not require actually encoding it via entropy encoding, the ECUQ search procedure can be executed very quickly. ECUQ only performs the entropy encoding step a single time, after the quantization values for the input vector have been found using the search procedure.

The remainder of this disclosure describes an example implementation of ECUQ according to certain embodiments, as well as various enhancements and modifications that may be applied to this implementation. It should be appreciated that FIG. 1 and the solution overview presented above are illustrative and not intended to be limiting. For example, while the foregoing overview focuses on using ECUQ for compressing gradient and model weight vectors during DL/FL training, ECUQ may be employed in any use case or setting where there is a need to perform efficient lossy compression of real valued vectors under size/bandwidth constraints. One of ordinary skill in the art will recognize other variations, modifications, and alternatives.

### 2. ECUQ Details

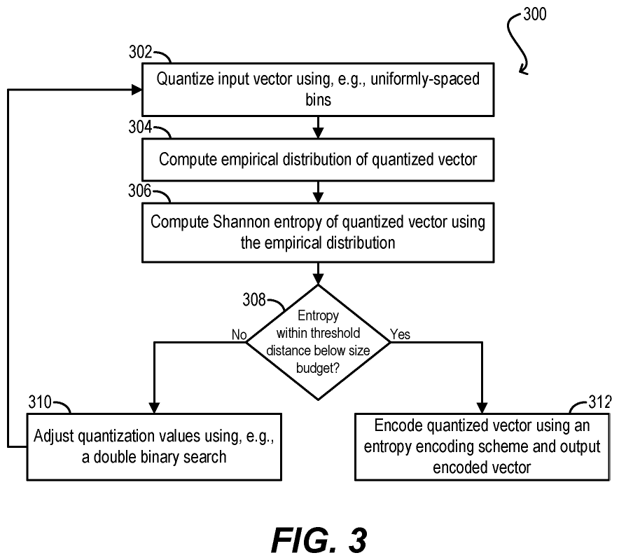

FIG. 3 depicts a flowchart 300 that may be performed by an ECUQ encoder for compressing an input vector via ECUQ according to certain embodiments. This ECUQ encoder may be implemented by, e.g., server application 102 and/or client applications 110(1)-(n) of FIG. 1 for compressing the model weight and/or gradient vectors that they generate as part of the DL/FL training process mentioned previously. For the purposes of this flowchart, let the input vector be denoted by x=(x(1), . . . , x(d))∈R^{d}, the minimal coordinate of x (i.e., min x(i)) be denoted by xₘᵢₙ, and the maximal coordinate of x (i.e., max x(i)) be denoted by xₘₐₓ. Further, let the size budget imposed on the compressed output vector be denoted by b, which means the average number of bits used to represent each coordinate in that vector cannot exceed b.

Starting with step 302 of flowchart 300, the ECUQ encoder can first quantize input vector x using, e.g., uniformly-spaced bins across the interval [xₘᵢₙ,xₘₐₓ]. In one set of embodiments, this step can involve (1) initially dividing the interval into K=2^{b} non-overlapping bins of equal size Δ=(xₘₐₓ−xₘᵢₙ)/K, (2) setting the quantization values (denoted by Q) to be the centers of those bins, and (3) quantizing x using the elements of Q (such that each element x(i) is assigned to its closest quantization value q∈Q). resulting in a quantized vector \hat{x}_{Q}.

At steps 304 and 306, the ECUQ encoder can compute an empirical distribution p_{Q} of quantized vector \hat{x}_{Q} by counting, for every q∈Q, the number of times that value appears in \hat{x}_{Q}, and can compute the Shannon entropy of \hat{x}_{Q} using p_{Q} (denoted by [symbol] (p_{Q})). This Shannon entropy value can be understood as the theoretical lower bound on the average number of bits per coordinate that may be used to encode \hat{x}_{Q} losslessly. Intuitively, this value cannot exceed log K=b. The following is the formula for computing [symbol] (p_{Q}) according to certain embodiments:

$$( {p}_{Q} ) = - {\sum }_{q ∈ Q} {p}_{Q} ( q ) log {p}_{Q} ( p ) \qquad Listing 1$$

Upon computing Shannon entropy [symbol] (p_{Q}), the ECUQ encoder can check whether [symbol] (p_{Q}) is within a threshold distance ϵ below the size budget b (step 308). In a particular embodiment, ϵ may be approximately 0.1.

If the answer to this question is no, the ECUQ encoder can adjust the set of quantization values Q using, e.g., a double binary search (step 310). This double binary search generally involves repeating the foregoing steps with an exponentially larger number of uniformly-spaced bins K in each search iteration until the resulting Shannon entropy overshoots b, and then performing a binary search between that high watermark of K and the previous value of K to find the maximal number of quantization values that results in a Shannon entropy within distance E below b.

Finally, once the entropy condition at step 308 satisfied, the ECUQ encoder can proceed to encode quantized vector \hat{x}_{Q} using an entropy encoding scheme like Huffman coding and output the resulting encoded/compressed vector \hat{x}ₑ (step 312). Such entropy encoding schemes generally get very close to the lower bound defined by the Shannon entropy and thus are optimal algorithms for performing lossless compression of discrete valued vectors.

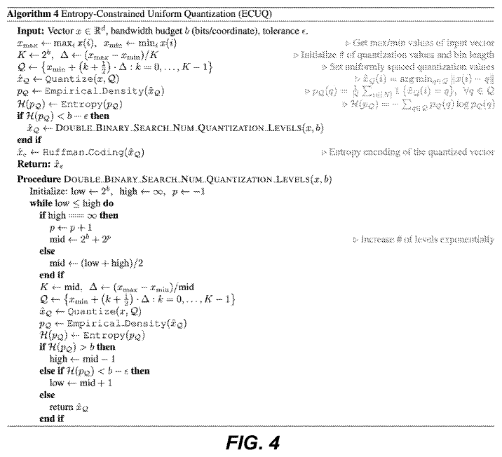

To further clarify the ECUQ encoding algorithm shown in FIG. 3, FIG. 4 depicts an implementation of this algorithm in pseudo-code format according to a particular embodiment. It should be noted that the corresponding ECUQ decoding algorithm simply involves performing entropy decoding of the encoded vector \hat{x}ₑ (which can be completed in linear time) and de-quantizing the decoded result.

### 3. Other Aspects and Alternatives

### 3.1 Other Search Heuristics

Although the foregoing description of ECUQ employs a double binary search to find the maximal number of bins K (and thus quantization values Q) that results in a Shannon entropy within threshold distance ϵ below size budget b, in alternative embodiments any other search algorithm or heuristic can be used for this purpose. For example, according to one naïve approach, the ECUQ encoder can simply perform a linear search (e.g., increase the number of bins by 1 in each search iteration until the maximal number of bins is found).

### 3.2 Non-Uniformly Spaced Bins

By imposing uniform spacing on the bins used to quantize the input vector, the ECUQ encoder can find the maximal number of quantization values very quickly, because it does not need to worry about adapting bin spacing in accordance with the input vector's content. Instead, the bin spacing is fixed/deterministic, regardless of the input.

However, uniform spacing is only one possible method for spacing the bins in a fixed manner, and other non-uniform methods can be employed. Examples of such other methods include K-means clustering and exponentially spaced bins.

### 3.3 Initializing the Number of Bins Based on Prior Information

The ECUQ encoding algorithm described in section (2) above begins with an initial K=2^{b} non-overlapping bins and adjusts this number upwards as the algorithm progresses. This is because even without any entropy encoding 2^{b} quantization values can be expressed with b bits, and thus 2^{b} serves as a lower bound on the number of quantization values that ECUQ should use.

However, in some scenarios, ECUQ may be applied iteratively to a vector that changes by a relatively small amount in each iteration. For example, this may occur when using ECUQ to compress model weights across training rounds in a DL or FL setting. In these scenarios, the ECUQ encoder may initialize K with the number of quantization values determined for the vector in the prior iteration (rather 2^{b}), as that number will likely be closer to the maximal number and thus reduce the number of computations needed for the ECUQ search procedure.

### 3.4 Employing Stochastic Quantization

In certain embodiments, instead of quantizing the input vector x in a deterministic fashion (e.g., rounding each x(i) to its closest quantization value q∈Q), the ECUQ encoder may employ stochastic quantization. For example, for each x(i), the encoder may assign x(i) to the closest quantization value below it with a probability of 0.7 and to the closest quantization value above it with a probability of 0.3. This achieves unbiasedness at the cost of increased quantization error, which can be useful for certain use cases such as distributed mean estimation.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, a vector comprising a plurality of real value coordinates;
determining, by the computer system, an interval between a minimal coordinate of the vector and a maximal coordinate of the vector;
dividing, by the computer system, the interval into K bins using a fixed rule;
determining, by the computer system, a set of K quantization values based on the K bins;
quantizing, by the computer system, the vector using the set of K quantization values, resulting in a quantized vector;
computing, by the computer system, an empirical distribution of the quantized vector;
computing, by the computer system, a Shannon entropy of the quantized vector based on the empirical distribution; and
checking, by the computer system, whether the Shannon entropy is within a threshold distance below a per-coordinate size budget b for the vector after compression.

2. The method of claim 1 further comprising:
upon determining that the Shannon entropy is within the threshold distance, encoding the quantized vector using an entropy encoding scheme; and
upon determining that the Shannon entropy is not within the threshold distance, performing a search procedure for finding a maximal number of quantization values that will cause the Shannon entropy of the quantized vector to fall within the threshold distance.

3. The method of claim 2 wherein the search procedure is a double binary search.

4. The method of claim 1 wherein the K bins are uniformly spaced across the interval.

5. The method of claim 1 wherein K is initialized to 2^{b}.

6. The method of claim 1 wherein K is initialized based a number of quantization values used to quantize another similar vector.

7. The method of claim 1 wherein the computer system quantizes the vector using deterministic quantization.

8. A non-transitory computer readable storage medium having stored thereon program code executable by a computer system, the program code causing the computer system to execute a method comprising:
receiving a vector comprising a plurality of real value coordinates;
determining an interval between a minimal coordinate of the vector and a maximal coordinate of the vector;
dividing the interval into K bins using a fixed rule;
determining a set of K quantization values based on the K bins;
quantizing the vector using the set of K quantization values, resulting in a quantized vector;
computing an empirical distribution of the quantized vector;
computing a Shannon entropy of the quantized vector based on the empirical distribution; and
checking whether the Shannon entropy is within a threshold distance below a per-coordinate size budget b for the vector after compression.

9. The non-transitory computer readable storage medium of claim 8 wherein the method further comprises:
upon determining that the Shannon entropy is within the threshold distance, encoding the quantized vector using an entropy encoding scheme; and
upon determining that the Shannon entropy is not within the threshold distance, performing a search procedure for finding a maximal number of quantization values that will cause the Shannon entropy of the quantized vector to fall within the threshold distance.

10. The non-transitory computer readable storage medium of claim 9 wherein the search procedure is a double binary search.

11. The non-transitory computer readable storage medium of claim 8 wherein the K bins are uniformly spaced across the interval.

12. The non-transitory computer readable storage medium of claim 8 wherein K is initialized to 2^{b}.

13. The non-transitory computer readable storage medium of claim 8 wherein K is initialized based a number of quantization values used to quantize another similar vector.

14. The non-transitory computer readable storage medium of claim 8 wherein the computer system quantizes the vector using deterministic quantization.

15. A computer system comprising:
a processor; and
a non-transitory computer readable medium having stored thereon program code that, when executed, causes the processor to:
receive a vector comprising a plurality of real value coordinates;
determine an interval between a minimal coordinate of the vector and a maximal coordinate of the vector;
divide the interval into K bins using a fixed rule;
determine a set of K quantization values based on the K bins;
quantize the vector using the set of K quantization values, resulting in a quantized vector;
compute an empirical distribution of the quantized vector;
compute a Shannon entropy of the quantized vector based on the empirical distribution; and
check whether the Shannon entropy is within a threshold distance below a per-coordinate size budget b for the vector after compression.

16. The computer system of claim 15 wherein the program code further causes the processor to:
upon determining that the Shannon entropy is within the threshold distance, encode the quantized vector using an entropy encoding scheme; and
upon determining that the Shannon entropy is not within the threshold distance, perform a search procedure for finding a maximal number of quantization values that will cause the Shannon entropy of the quantized vector to fall within the threshold distance.

17. The computer system of claim 16 wherein the search procedure is a double binary search.

18. The computer system of claim 15 wherein the K bins are uniformly spaced across the interval.

19. The computer system of claim 15 wherein K is initialized to 2^{b}.

20. The computer system of claim 15 wherein K is initialized based a number of quantization values used to quantize another similar vector.

21. The computer system of claim 15 wherein the computer system quantizes the vector using deterministic quantization.
